(19) United States
(12) Patent Application Publication
(10) Pub. No.: US 2026/0053132 A1
(43) Pub. Date: Feb. 26, 2026

(54) Drone and Method

(71) Applicant: Syngenta Crop Protection AG, Basel (CH)

(72) Inventors: Ben Wu, Singapore (SG); Andre Oliveira, Singapore (SG); Soo Keat Tan, Singapore (SG); Candra Putra, Jatisari (ID); Ray Hsiao, Neipu (TW); Neal Bird, Berkshire (GB); Graham Sanderson, Basel (CH); Ali Asad, Jatisari (ID); Muhammad Ridhwan, Jatisari (ID)

(73) Assignee: Syngenta Crop Protection AG, Basel (CH)

(21) Appl. No.: 19/099,624

(22) PCT Filed: Jul. 27, 2023
(86) PCT No.: PCT/EP2023/070803

§ 371 Date: Jan. 29, 2025

(30) Foreign Application Priority Data
Aug. 3, 2022 (SG) 10202250662T

(51) Int. Cl. A01M 7/00; A01N 25/04; A01P 13/00; B64U 20/00; B64U 101/45

(52) U.S. Cl. CPC A01M 7/0089; A01M 7/0042; A01N 25/04; A01P 13/00; B64U 20/00; B64U 2101/45

(57) ABSTRACT

A method of applying a herbicide to a flood field (1). The method comprises providing an unmanned aerial vehicle (UAV) (2), and flying the UAV (2) along a plurality of substantially parallel spray flight paths (31). The method also comprises spraying a herbicide composition from the UAV (2) onto the surface of the flood field (1) at a plurality of application areas (11), each one of the plurality of application areas (11) corresponding to one of the plurality of spray flight paths (31), each application area (11) being separated from adjacent application areas (11) by a dispersion area (12) into which herbicide composition sprayed onto the flood field (1) surface can disperse. The herbicide composition comprises an aqueous emulsion (EW).

that the ratio between the time taken for a UAV to apply the herbicide composition to a flood field of a given size and the time taken for an operative to manually apply the herbicide composition to a flood field of the same size is around 1:15. For example it may take a UAV around 8 minutes to apply the herbicide composition to a flood field when it would take an operative around 2 hours to apply the herbicide composition to the same flood field.

Aqueous emulsions (EV) have benefits in that they are simple to manufacture and have good chemical stability and can be applied to the flood field directly or upon dilution and the spontaneous emulsion of the oil droplets containing the active ingredient(s) will lead to the droplets floating or rising to float and dispersing across the surface of the field with no sedimentation. Thus, upon application, spontaneous emulsion of the active ingredient in the aqueous emulsion will lead to droplets floating or rising to float and dispersing across the surface of the flood field. In this manner the aqueous emulsion will disperse into the dispersion areas from the application areas. This allows coverage of the flood field to be achieved by flying the UAV over alternate rows only (i.e., alternate application areas and dispersion areas). As such, the UAV does not need to fly over the entire flood field, further reducing application times.

The application areas may be predetermined. The location and size of each application area may be predetermined. The location and size of each application area may be predetermined before the herbicide composition is applied to the flood field.

The dispersion areas may be predetermined. The location and size of each dispersion area may be predetermined. The location and size of each dispersion area may be predetermined before the herbicide composition is applied to the flood field. The size of the dispersion areas might be such that, when the herbicide composition is sprayed onto one of the application areas, the herbicide composition disperses to at least half of the width of the adjacent dispersion areas. The herbicide composition may disperse across the entire width of each dispersion area when the composition is sprayed onto the adjacent application areas.

The UAV may fly in a first direction along a first one of the spray flight paths and in a second direction, which is opposite to the first direction, along any spray flight paths which are adjacent to the first one of the spray flight paths. The UAV may fly in a back-and-forth pattern along the spray flight paths. Advantageously, the UAV need not fly over the entire field and so application time is optimised. Each one of the plurality of spray flight paths may be connected to adjacent ones of the plurality of spray flight paths by a non-spray flight path.

Each one of the plurality of predetermined application areas may be from about 4 m to about 6 m wide. Preferably, each one of the plurality of predetermined application areas may be about 3 m wide. Each predetermined dispersion area may be from about 3 m to about 5 m wide. Preferably, each predetermined dispersion area may be about 4 m wide.

The application areas may be spaced from an edge of the flood field or from an edge of the planted region of the flood field. The application areas may be spaced from an edge of the flood field or from an edge of the planted region of the flood field by boundary dispersion areas. The herbicide composition may disperse into the boundary dispersion areas. The boundary dispersion areas may be predetermined. The size of each boundary dispersion area may be predetermined. The size of each boundary dispersion area may be predetermined before the herbicide composition is applied to the flood field. The size of the boundary dispersion areas might be such that the herbicide composition disperses through the entirety of the boundary dispersion areas when the herbicide composition is sprayed onto the application areas. The size of the boundary dispersion areas might be such that the herbicide composition disperses up to at least an edge of the planted region of the flood field when the herbicide composition is sprayed onto the application areas.

The application areas may be spaced from an edge of the flood field or from an edge of the planted region of the flood field by about 1 m to about 3 m. Preferably, the application areas may be spaced from an edge of the flood field or from an edge of the planted region of the flood field by about 2 m. Advantageously, the provision of boundary dispersion areas may further ensure that drift of the herbicide composition does not lead to the herbicide composition entering unwanted areas.

The UAV may have a nozzle and the herbicide composition may be sprayed through the nozzle. The nozzle may be a low-drift nozzle. The expected spread and drift of the herbicide composition when sprayed through the nozzle may be used to select or determine appropriate widths of the application areas. A suitable nozzle may be selected for a predetermined application area. A suitable nozzle may be selected for a predetermined application area for a given flight height. For example, the nozzle may produce droplets of herbicide composition, each within a predetermined range of droplet sizes. The nozzle may be selected such that the droplet sizes are sufficiently fine to provide spreading of the herbicide composition across the application areas, but are large enough to reduce the risk of the herbicide composition drifting into unwanted areas. Advantageously, the range of droplet sizes can be used to select appropriate widths of the application areas. The UAV may have a plurality of nozzles. For example, the UAV may have four nozzles.

The UAV may continuously spray the herbicide composition while travelling along any one of the plurality of spray flight paths. The UAV may intermittently spray the herbicide composition while travelling along any one of the plurality of spray flight paths.

The UAV may fly from about 1.5 m to about 3 m above the surface of the flood field during application of the herbicide composition. For example, the UAV may fly about 2 m above the surface of the flood field during application of the herbicide composition.

The herbicide composition may be sprayed from the UAV to arrive at the surface of the flood field with a spray area. The spray area may be a function of any combination of the UAV configuration, the nozzle configuration and the flight height above the surface of the flood field. The spray area may have a width dimension which is substantially the same as the width of the application area. The spray area may be altered by altering the flight height of the UAV.

According to a second aspect of the invention there is provided a method of applying a herbicide to a plurality of flood fields, the method comprising applying the herbicide to each flood field using the aforementioned method, and further including the step of flying the UAV between flood fields, for example between adjacent flood fields. The UAV may be flown between adjacent flood field along non-spraying routing flight paths.

According to a third aspect of the invention there is provided a method of computing the flight path of an unmanned aerial vehicle, UAV, for example over a flood field or over a plurality of flood fields, to apply a herbicide composition comprising an aqueous emulsion to a or the flood field, from the UAV, the method comprising:
determining a plurality of application areas on the field, each application area being separated from adjacent application areas by a dispersion area;
associating a spray flight path with each application area, such that when the UAV flies along each spray flight path and sprays the composition, the composition is sprayed onto the respective application area and can disperse into the dispersion areas;
wherein the size of the dispersion areas are determined based upon dispersion properties of the composition.

The dispersion properties may include an expected amount of dispersion for droplets of the herbicide composition when present on the surface of the water of the flood field. The dispersion properties may be determined, at least in part, by the viscosity of the herbicide composition. Aqueous emulsion formulations, particularly concentrated formulations, typically have high viscosities, which are undesirable for direct splash application into the field and are aesthetically less pleasing for the end user, while low viscosity compositions struggle to achieve sufficient concentration of the oil phase, and by extension the active ingredient(s). The viscosity of the herbicide composition may be less than 600 cps. The viscosity of the herbicide composition may be less than 500 cps, 450 cps, 400 cps, or even 350 cps.

Advantageously the flight path is computed to provide coverage of the flood field in the fewest number of rows possible whilst providing sufficient dispersion of the herbicide composition and reducing the risk of drift into unwanted areas.

The method of computing the flight path may further comprise determining non-spray flight paths to connect ends of each one of the plurality of spray flight paths to adjacent ones of the plurality of spray flight paths.

The flight path may be fixed before the UAV flies along the flight path. The flight path may be adjusted or updated as the UAV flies along the flight path.

The plurality of application areas may be determined based upon the UAV spraying a composition comprising one or more active ingredients and one or more surfactants onto the plurality of application areas, preferably wherein the composition has a viscosity of less than 600 cps.

The method may comprise computing non-spraying routing flight paths, along which the UAV may fly between different flood fields, for example between adjacent flood fields. Advantageously, the flight time of the UAV may be minimised by providing the shortest possible non-spraying routing flight paths between flood fields.

According to a fourth aspect of the invention there is provided an unmanned aerial vehicle, UAV, system configured to apply a composition of herbicide with an aqueous emulsion to a flood field, the UAV system comprising:
a UAV which has a storage tank for storing the herbicide composition, and a nozzle for spraying the herbicide composition;
a memory for storing computer readable instructions relating to flight path for applying the herbicide composition to the flood field;
a controller for controlling the flight and spraying operation of the UAV based on the computer readable instructions;
wherein the UAV is configured to:
   fly along a plurality of substantially parallel spray flight paths;
   spray the composition onto a plurality of application areas of the field, each application area corresponding to one of the plurality of spray flight paths, and each application area being separated from adjacent application areas by a dispersion area, into which the composition can disperse.

The nozzle may have a configuration such that the composition is sprayed or is sprayable with a droplet size which is within a predetermined range of droplets sizes. Advantageously, in use, the composition may arrive at the flood field with a known spray area. For example, the spray area may be determined to have a dimension equal to the width of the application area, based upon the flight height of the UAV. The UAV may comprise a plurality of nozzles through which the composition is sprayed or is sprayable. The UAV may comprise four nozzles through which the composition is sprayed or is sprayable.

The controller may be comprised in the UAV.

The flight path may be computed using the aforementioned method of computing the flight path of an unmanned aerial vehicle.

The UAV may be configured to spray a composition comprising one or more active ingredients and one or more surfactants, preferably wherein the composition has a viscosity of less than 600 cps.

The memory may be comprised in the UAV.

The UAV system may further comprise a computer or processor for computing the flight path of the UAV.

The UAV system may further comprise:
a transmitter for transmitting a signal representative of the computed flight path to the UAV to be used by the controller for controlling the UAV to fly along the computed flight path;
wherein the UAV further comprises a receiver for receiving the signal representative of the computed flight path.

The composition of the above-described aspects of the invention may comprise one or more active ingredients and one or more surfactants. The composition may have a viscosity of less than 600 cps.

The oil:aqueous phase ratio, p, may be 1.1:1 or higher, preferably 1.5:1 or higher. Advantageously these higher ratios of the compositions allows a more concentrated composition to be prepared.

The one or more active ingredients may be present in an amount of from 0.1 to 40% by weight.

The one or more surfactants may be selected from the group comprising: polyalkylene glycols, butyl polyalkylene oxide block copolymers, ethoxylated sorbitol esters, polyoxyethylene tridecyl phosphate esters and anionic acrylic copolymers.

The composition may comprise xanthan gum, preferably in an amount of less than 0.2% by weight. Surprisingly and counter-intuitively, it has been found that xanthan gum acts as a thinning agent in context of the present invention and serves to reduce the viscosity. It may also aid in the formation of fine droplets upon application.

The composition may comprise an adjuvant, preferably an adjuvant comprising an alkyl methyl ester. Advantageously the adjuvant improves the efficacy of the composition. It was also advantageously found that the presence of the adjuvant helps in the formation of fine droplets of the composition, such as those with a D95 of less than 2.5 microns.

Having thus described the invention in general terms, reference will now be made to the accompanying drawings wherein:

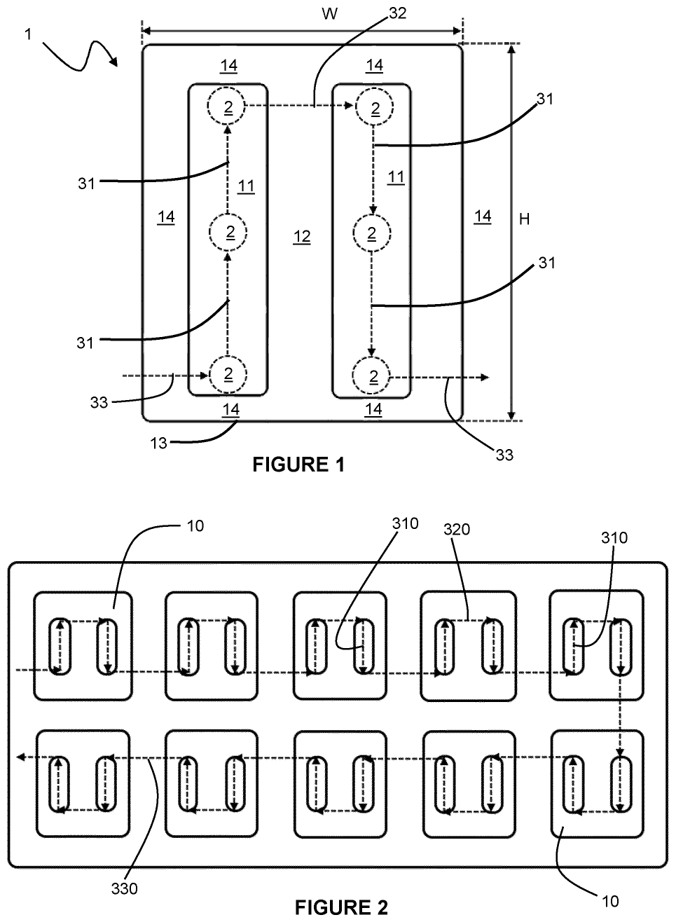

FIG. 1 is a schematic of a flood field to which a herbicide composition is applied;

FIG. 2 is a schematic of a plurality of flood fields; and

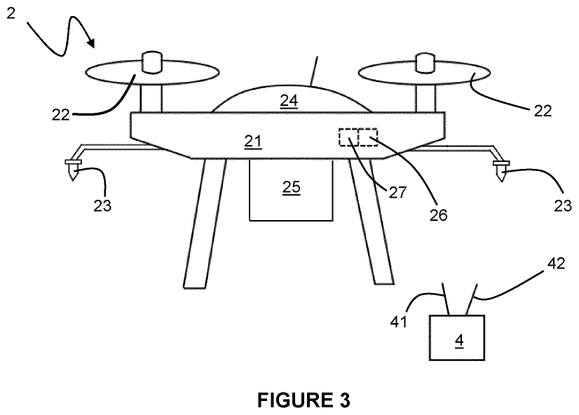

FIG. 3 is a schematic of an unmanned aerial vehicle (UAV) for apply a herbicide to a flood field.

Referring firstly to FIG. 1, there is shown, schematically, a flood field 1. In this example the flood field 1, which might otherwise be known as a paddy field, is for growing rice. In other examples the flood field 1 could be for growing any suitable plants or crops. In this example the flood field 1 is rectangular in shape, having a height H and a width W. It will be appreciated that the height H and width W of the flood field 1 could be of any values which are suitable for growing the respective plants or crops.

The flood field 1 has a plurality of application areas 11. The application areas 11 are substantially parallel to one another. The application areas 11 are parts of the flood field 1 to which a herbicide composition is to be applied by an unmanned aerial vehicle (UAV) 2. In this example, the application areas 11 are predetermined in that each of their location and size is substantially predetermined before the herbicide composition is applied thereto. In this example, each application area 11 is about 3 m wide.

Each application area 11 is separated from the other, adjacent application area 11 by a dispersion area 12. In this example the dispersion area 12 is predetermined in that the location and size is substantially predetermined before the herbicide composition is applied to the application areas 11. In this example the dispersion area 12 is about 4 m wide. That is, the distance between adjacent application areas 11 is about 4 m.

Each application area 11 is spaced from edges 13 of the flood field 1, or from edges of the planted region (not shown) of the flood field 1. This spacing provides boundary dispersion areas 14. In this example the boundary dispersion areas 14 are predetermined in that their sizes are substantially predetermined before the herbicide composition is applied to the application areas 11. In this example the application areas 11 are spaced by about 2 m from the edges 13 of the flood field 1. That is, the boundary dispersion areas 14 are about 2 m wide.

While only two application areas 11 are shown in FIG. 1, the numbers of application areas 11 will be determined by the width W of the flood field W, as well as the widths of the boundary dispersion areas 14, dispersion areas 12 between adjacent application areas 11, and of the application areas 11. Therefore, any number of application areas 11 might be present. Furthermore, it will be appreciated that the width W of the flood field 1, as well as the widths of the boundary dispersion areas 14, dispersion areas 12 between adjacent application areas 11, and of the application areas 11 might be determined based upon the type of herbicide composition applied thereto, as well as other conditions such as environmental conditions and the configuration of the UAV 2.

In order to apply the herbicide to the flood field 1 the UAV is flown along spray flight paths 31. The spray flight paths 31 are substantially parallel to one another. Each spray flight path 31 passes over one of the application areas 11. In other words, there is a corresponding spray flight path 31 for each application area 11. While the UAV 2 flies along a spray flight path 31 the herbicide composition is sprayed onto the surface of the flood field 1. The herbicide composition may be sprayed continuously or intermittently, depending upon factors such as the UAV configuration, battery life and water volume in the flood field 1.

In this example the UAV 2 is flown at around 2 m above the surface of the flood field 1 during application of the herbicide composition. However, it will be appreciated that the flight height is determined based upon the spread and/or drift of the herbicide composition, and so any flight height is usable.

The herbicide composition is sprayed from the UAV 2 to arrive at the surface of the flood field 1 with a spray area. The size of the spray area is at least partially defined by the flight height of the UAV 2 above the surface of the flood field 1. In this example, the spray area has a width dimension which is substantially the same as the width of the application areas 11. That is, as the UAV 2 is flown along a given spray flight path 31, the herbicide composition is sprayed from UAV 2 so that the resulting spray area covers a corresponding application area 11.

Ends of each spray flight path 31 are connected to one another by a non-spray flight path 32. In this way the UAV 2 flies in a back-and-forth pattern, flying in a first direction along one spray flight path 31, flying to the adjacent spray flight path 31 by flying along the relevant non-spray flight path 32, and flying in a second direction which is opposite to the first direction along the adjacent spray flight path 31. The UAV 2 also flies along non-spraying routing flight paths 33 to enter and exit the area above the flood field 1 to begin and end, respectively, the spraying process. Herbicide composition is not sprayed when the UAV 2 is flying along non-spraying routing flight paths 33. Also, while the UAV 2 flies along each non-spray flight 32 path herbicide composition is not sprayed from the UAV 2.

As will be appreciated, if there are more than two application areas 11 then each application area 11 will have a corresponding spray flight path, and the UAV 2 will fly in the aforementioned back-and-forth pattern over these.

When the herbicide composition is sprayed onto the surface of the flood field 1 in the application areas 11, the herbicide composition will disperse from the application areas 11 into the dispersion area 12 and the boundary dispersion areas 14. Therefore, there is no necessity to spray the herbicide composition into the dispersion area 12 and into the boundary dispersion areas 14. In this way the entire flood field 1 will receive the herbicide composition in a time efficient manner, while removing or reducing the risk of herbicide composition drifting into unwanted areas.

Referring now to FIG. 2 there is shown a plurality of flood fields 10. Each flood field 10 is the same as the flood field 1 described with reference to FIG. 1. In this example there are 10 flood fields 10, but it will be appreciated that there may be any number of flood fields 10. In order to apply the herbicide composition to all of the flood fields 10, one UAV 2 or multiple UAVs 2 may be used. FIG. 2 illustrates the use of one UAV 2 to apply herbicide composition to all 10 flood fields 10. The UAV 2 has spray flight paths 310 which pass over each application area of each flood field 10, as was the case with the flood field 1 described with reference to FIG. 1. Similarly, non-spray flight paths 320 connect the spray flight paths 310 in each flood field 10, as in the flood field 1 of FIG. 1. Non-spraying routing flight paths 330 are provided along which the UAV 2 enters and exits each flood field 10, as in the flood field 1 of FIG. 1. The non-spraying routing flight paths 330 also connect spray flight paths 310 of adjacent flood fields 10. The non-spraying muting flight paths 330 between adjacent flood fields 10 are determined to have the shortest possible distance. In this way the flight time of the UAV 2 is minimised.

In another example a first UAV 2 may be used to apply herbicide composition to the top row, as orientated in FIG. 2, of flood fields 10 and a second UAV 2 may be used to apply herbicide composition to the bottom row, as orientated in FIG. 2, of flood fields 10. The non-spraying routing flight paths 330 of the top row are the same as those shown in FIG. 2, and the non-spraying routing flight paths of the bottom row are the same as those of the top row.

It will be appreciated that whilst these two examples of flight paths for spraying multiple flood fields 10 are described, any flight paths could be provided for any number of UAVs 2.

The flight path of the UAV 2, as described with reference to FIG. 1 or to FIG. 2 which includes the spray flight paths 31, 310, the non-spray flight paths 32, 320 and the non-spraying routing flight paths 33, 330, is computed to spray the herbicide composition into the application areas 11 of the flood fields 1, 10 in an efficient manner.

In order to compute the flight path the plurality of application areas 11 are first determined, with the application areas 11 being separated by the dispersion area 12. The application areas 11 are determined using the known width W and height H of the flood field 1, 10. The width W is then divided into a minimum number of application areas 11 wherein, when the composition is sprayed onto the flood field, the composition will fully disperse into the dispersion and boundary dispersion areas 12, 14, as discussed below. The application areas 11 may be determined based on, for example aerial images (not shown). The application areas 11 may be mapped onto particular areas of the flood fields 1, 10, for example onto lines of crops. The computation of the flight path and of the application areas may also be determined based upon other factors which might affect the application of the herbicide composition, such as weather, the UAV configuration (e.g., nozzles selection and spraying mode), and the type of herbicide.

Each spray flight path 31, 310 is then associated with each application area 11 such that when the UAV 2 flies along each spray flight path 31, 310 and sprays the herbicide composition, the herbicide composition is sprayed onto the respective application area 11 and can disperse into the dispersion area 12. The herbicide composition can also disperse into the boundary dispersion areas 14.

The size of the dispersion areas 12, 14 are determined based upon the dispersion properties of the herbicide composition. For example, the size of the dispersion and boundary dispersion areas 12, 14 are determined based upon the viscosity of the herbicide composition, and any other properties which affect the dispersion thereof, through the water of the flood field 1, 10. The size of the dispersion area 12 is such that, when the herbicide composition is sprayed onto one of the application areas 11, the herbicide composition disperses to at least half of the width of the dispersion area 12. Similarly, when the herbicide composition is sprayed onto the other of the application areas 11 the herbicide composition disperses to at least half of the width of the dispersion area 12. In this way the herbicide composition disperses across the entire width of the dispersion area 12. The size of the boundary dispersion areas 14 is such that the herbicide composition disperses through the entire boundary dispersion areas 14 or disperses at least to the edge of the region in which crops are planted.

The non-spray flight paths 32, 320 are also determined to connect ends of one of the spray flight paths 31, 310 in each flood field 1, 10, to the other one of the spray flight paths 31, 310 in the flood field 1, 10. The non-spraying routing flight paths 33, 330 are computed to minimise flight time of the UAV 2.

The flight path is computed to account for all factors which will affect the application of the herbicide, for example weather conditions, the type of plant in the flood field 1, the type of herbicide composition and the configuration of the UAV 2 (e.g., nozzles selection and spraying mode).

In one example the flight path is computed before the UAV 2 takes flight. The flight path is computed by a computer or processor which may be a part of the UAV 2 or may be external to the UAV 2, for example computed by the computer 4 in FIG. 3 and transmitted to the UAV 2. The flight path may be fixed before the UAV 2 begins flight along the flight path or may be adjusted as the UAV 2 flies along the flight path.

In another example the flight path is computed or adjusted as the UAV 2 flies. The flight may be computed or adjusted based on, for example, aerial shots of the flood field 1, 10, conditions experienced or measured by the UAV 2 or weather conditions. The flight path is computed by a computer which may be a part of the UAV 2 or may be external to the UAV, for example computed by the computer 4 in FIG. 3 and transmitted to the UAV 2.

In this example the herbicide composition is an aqueous emulsion of two active ingredients and one or more surfactants. The herbicide composition preferably has a viscosity of less than 600 cps.

The herbicide composition is an aqueous emulsion (EV). In this example the oil:aqueous phase ratio, φ, is 1.1:1 or higher, preferably 1.5:1 or higher. The one or more surfactants are selected from the group comprising: polyalkylene glycols, butyl polyalkylene oxide block copolymers, Ethoxylated sorbitol esters, polyoxyethylene tridecyl phosphate esters and anionic acrylic copolymers. The herbicide composition comprises xanthan gum, preferably in an amount of less than 0.2% by weight. The herbicide composition comprises an adjuvant, preferably an adjuvant comprising an alkyl methyl ester.

Referring now to FIG. 3 there is shown a schematic of the UAV 2 as part of a UAV system, which is used to apply the herbicide composition to the flood field 1 of FIG. 1 or to a plurality of flood fields 10 as shown in FIG. 2. The UAV 2 may be otherwise known as a drone. The UAV 2 has a body 21 and a plurality of propellers 22 as is known in the art. The UAV 2 has a plurality of nozzles 23 as shown in FIG. 3. In this example there are four nozzles. Each nozzle 23 is preferably a low-drift nozzle, for example a Lechler® DK 120-15 nozzle, or one of a TeeJet® SJ3 015, TP0001 or TP0015 nozzle. The nozzle type is selected based upon the expected droplet size of the herbicide composition when sprayed through the nozzle. That is, the droplet size of each nozzle is predictable such that the droplet size is within a predetermined range of droplet sizes. This allows the spray are of the herbicide composition, upon arriving at the flood field, to be determined for the various flight heights of the UAV 2. The UAV 2 has a storage tank 25 for storing the herbicide composition.

The UAV 2 has a transmitter receiver 24 for receiving signals. The UAV 2 has control circuitry 27 including a processor 26 for processing data received at the transmitter receiver 24. The control circuitry 27 is also for controlling the operation of the UAV 2. The data is preferably in the form of computer readable instructions which are processed by the processor 26 and implemented by the control circuitry 27. In some examples the UAV 2 has any number of a global positioning system (GPS) (not shown), a compass (not shown) and a camera (not shown). Any or all of these are controlled by the control circuitry 27.

The UAV system has a controller for controlling the operation of the UAV 2. The controller controls the flight of the UAV 2 along the flight path and the spraying of the herbicide composition from the UAV 2.

The UAV system has a memory for storing instructions and/or operation settings. The memory may also store computer readable instructions relating to the flight path, so that the controller can control the UAV 2 to fly along the flight path and to spray the herbicide composition when flying along the spray flight paths 31.

In this example the UAV system controller is a computer 4 comprising a processor and memory. That is, the processor and memory are located externally to the UAV 2. The computer readable instructions are provided to the UAV 2 from the computer 4. The computer 4, computes the flight path and transmits a signal representative of the flight path to the UAV 2 using an aircraft control transmitter 41 and a second data receiver transmitter antenna 42. The second data antenna 42, in some examples, is for receiving images from the camera on the UAV 2, for example a live feed. In some examples the computer 4 has a screen (not shown) to display the live feed and any other operating parameters of the UAV 2. In some examples an operator can control any number of aspects of the operation of the UAV 2 manually using inputs on the controller.

The computer 4 is usable to control any number of UAVs 2 simultaneously.

### EXAMPLE

In order to illustrate the time savings achieved with the herbicide composition application method of this invention, a comparison was made with the time taken to apply herbicide to the entire flood field using a UAV, that is spraying over adjacent application areas without separation. This is, for example, the application method used for applying fertiliser to a field. It should be noted that application of the herbicide to an entire field, as in this example, is not recommended due to the risk of the herbicide drifting into unwanted areas, and this was performed for illustration of time saving only. The herbicide composition was also applied to the flood field by an operative, for comparison.

In the example herbicide compositions were sprayed onto 14 m×8 m (112 m²) flood fields containing rice, to remove general weeds. The UAV was flown about 2 m above the surface of the flood field and four Lechler® DK 120/15 were fitted to the UAV. The spray volume was 30 litres per hectare (L/ha). The wind speed during the trials was 0-1.9 m/s. The UAV spray trials were performed with two compositions of herbicide. A DJI MG1-P UAV was used for the application.

An operative was also used to spray a herbicide composition of Bispiribak Sodium (100) GA/L) to the flood field, using a knapsack sprayer. The spray volume in this case was 400 L/Ha.

All trials showed excellent weed control and no phytotoxicity in the rice.

Table 1 shows a comparison of application times of the herbicide application for when spraying the entire field using an operative, when spraying the entire field with a UAV, and when spraying in alternate rows with a UAV.

TABLE 1

| | Applied | UAV flight | UAV flight |
|---|---|---|---|
| | using an | over entire | over |
| | operative | flood field | alternate rows |
| Time (seconds) / | ≈201 | 17-18 | 11-12 |
| 140 m² | | | |
| Time (minutes) / | ≈240 | 20-21 | 13-14 |
| 10,000 m² (1 ha) | (≈4 hours) | | |

As shown in Table 1, flying over alternate rows, with a UAV, provides a 33-35% decrease in application time over flying over the entire field with a UAV. Application using a UAV shows a dramatic decrease in application time over using an operative.

1. A method of applying a herbicide to a flood field, the method comprising:
providing an unmanned aerial vehicle (UAV);
flying the UAV along a plurality of substantially parallel spray flight paths;
spraying a herbicide composition comprising an aqueous emulsion (EW) from the UAV onto the surface of the flood field at a plurality of application areas, each one of the plurality of application areas corresponding to one of the plurality of spray flight paths, each application area being separated from adjacent application areas by a dispersion area into which herbicide composition sprayed onto the flood field surface can disperse.

2. The method according to claim 1, wherein each one of the plurality of application areas is from about 4 m to about 6 m wide.

3. The method according to claim 2, wherein each dispersion area is from about 3 m to about 5 m wide.

4. The method according to claim 1 wherein each of the application areas is spaced from an edge of the flood field or from an edge of the planted region of the flood field.

5. The method according to claim 4, wherein each of the application areas is spaced from an edge of the flood field or from an edge of the planted region of the flood field by about 1 m to about 3 m.

6. The method according to claim 1, wherein each one of the plurality of spray flight paths is connected to adjacent ones of the plurality of spray flight paths by a non-spray flight path.

7. The method according to claim 1, wherein the UAV has a nozzle and the herbicide is sprayed through the nozzle.

8. The method according to claim 1, wherein spraying the herbicide composition comprises spraying a composition comprising one or more active ingredients and one or more surfactants, preferably wherein the composition has a viscosity of less than 600 cps.

9. A method of computing the flight path of an unmanned aerial vehicle (UAV) over a flood field to apply a herbicide composition comprising an aqueous emulsion thereto, from the UAV, the method comprising:
determining a plurality of application areas on the field, each application area being separated from adjacent application areas by a dispersion area;
associating a spray flight path with each application area, such that when the UAV flies along each spray flight path and sprays the composition, the composition is sprayed onto the respective application area and can disperse into the dispersion areas;
wherein the size of the dispersion areas are determined based upon dispersion properties of the composition.

10. The method according to claim 9, further comprising determining non-spray flight paths to connect ends of each one of the plurality of spray flight paths to adjacent ones of the plurality of spray flight paths.

11. The method according to claim 9, wherein the plurality of application areas are determined based upon the UAV spraying a composition comprising one or more active ingredients and one or more surfactants onto the plurality of application areas, preferably wherein the composition has a viscosity of less than 600 cps.

12. An unmanned aerial vehicle (UAV) system configured to apply a composition of herbicide with an aqueous emulsion (EW) to a flood field, the UAV system comprising:
a UAV which has a storage tank for storing the herbicide composition, and a nozzle for spraying the herbicide composition;
a memory for storing computer readable instructions relating to a flight path for applying the herbicide composition to the flood field; and
a controller for controlling the flight and spraying operation of the UAV based on the computer readable instructions;
wherein the UAV is configured to:
fly along a plurality of substantially parallel spray flight paths;
spray the composition onto a plurality of application areas of the field, each application area corresponding to one of the plurality of spray flight paths, and each application area being separated from adjacent application areas by a dispersion area, into which the composition can disperse.

13. The UAV system according to claim 12, wherein the nozzle has a configuration such that the composition is sprayed or is sprayable with a droplet size which is within a predetermined range of droplets sizes.

14. The UAV system according to claim 12, wherein the flight path is computed
determining a plurality of application areas on the field, each application area being separated from adjacent application areas by a dispersion area;
associating a spray flight path with each application area, such that when the UAV flies along each spray flight path and sprays the composition, the composition is sprayed onto the respective application area and can disperse into the dispersion areas;
wherein the size of the dispersion areas are determined based upon dispersion properties of the composition.

15. The UAV system according to claim 12, wherein the UAV is configured to spray a composition comprising one or more active ingredients and one or more surfactants, preferably wherein the composition has a viscosity of less than 600 cps.

16. The UAV system according to claim 12, further comprising a computer or processor for computing the flight path of the UAV

17. The UAV system according to claim 16, further comprising
a transmitter for transmitting a signal representative of the computed flight path to the UAV for controlling the UAV to fly along the computed flight path;
wherein the UAV further comprises a receiver for receiving the signal representative of the computed flight path.

18. The UAV system according to claim 17, wherein the UAV further comprises control circuitry for processing the signal representative of the computed flight path and for controlling the operation of the UAV.
